(19) United States
(12) Patent Application Publication
(10) Pub. No.: US 2001/0056313 A1
(43) Pub. Date: Dec. 27, 2001

(54) Object locating and retrieving system utilizing labels

(76) Inventor: William Joseph Osborne JR., Carlisle, PA (US)

Correspondence Address: William Joseph Osborne, Jr., 155 Shushart Rd., Carlisle, PA, 17013, US

(21) Appl. No.: 09/851,484

(22) Filed: May 8, 2001

Related U.S. Application Data
(60) Provisional application No. 60/202,817, filed on May 8, 2000.

(51) Int. Cl. G05B 15/00

(52) U.S. Cl. 700/245; 700/262

(57) ABSTRACT

A system for locating and retrieving objects of a variety of sizes, shapes, weights, positions and orientations is disclosed. The system comprises a robot arm, a control computer, a gripper, an operating sequence, a set of objects and a set of machine-readable or bar code labels mounted on said objects, and a scanner. The system locates a requested object, calculates its position and moves the gripper into position for pickup. Alternate embodiments include mounting on a wheelchair and use in medical, dental, library and stockpicking environments.

### CROSS REFERENCES TO RELATED APPLICATIONS

Provisional Patent Application No. 60/202,817, filed May 8, 2000 contains a brief statement of this invention. A Regular Patent Application entitled Self Feeding Apparatus with Hover Mode, filed May 7, 2001 by the same inventor also contains a brief description of this system and claims it.

### Background

1. Field of Invention

This invention relates to automatic or robotic systems which locate and retrieve objects, specifically systems which locate objects which are not in prerecorded positions by use of a machine readable label.

2. Discussion of Prior Art

U.S. Pat. 5,974,365, System for measuring the location and orientation of an object, Robert R; Mitchell, 1999 discloses system to locate an object in three space. It has no means for grasping and retrieving an object It does not use machine readable labels.

WIPO Patent WO9418100A1, European Patent EP0681549B 1: System for Identifying, searching for and locating objects, Jacques Trellet, 1994, discloses a system which uses a scanner and active labels which reveal their location when polled. It does not use passive labels. It has no means for grasping and retrieving an object.

U.S. Pat. No. 4,081,669, Recognition system for class II robots discloses a system which recognizes signals from known sources and calculates the position of the robot from them. It has no means of grasping or retrieving objects and does not work with passive labels.

U.S. Pat. No. 6,017,125 Bar Coded Retroreflective Target, Charles S. Vann, 1997, discloses a system using a laser scanner wherein the position of a reflective target containing a bar code can be calculated accurately with six degrees of freedom. It has no means for grasping or retrieving an object.

U.S. Pat. No. 5,426.581, Using a bar code scanner to calibrate positioning of a robotic system, Gregory Kishi, 1995, discloses a method and system for teaching a robotic accessor the actual location of the center of targets in an automated storage and retrieval system. All objects in this system are identical or very similar. All are stored in rack or shelving. There is no means or method of grasping objects of many different forms in a variety of positions and orientations.

### SUMMARY

In accordance with the current invention an object locating and retrieving system uses machine readable labels and a scanner to flexibly find, grasp and pick up objects which may be in any position or orientation.

### OBJECTS AND ADVANTAGES

Accordingly, several objects and advantages of my object retrieving system are:

a. It can locate and retrieve objects anywhere it can see them within its envelope without requiring objects to be placed in a rack or fixture, without requiring objects' position and location to be known in advance. This permits it to do order picking in a stockroom where the positions of objects are not known in advance.

b. It can reliably find and grasp objects randomly located in a clutter without the need for expensive image processing.

c. Unlike a camera based vision system, it can differentiate between objects that are physically identical but internally different, such as boxes containing different items or computer chips with the same packaging and different circuits.

d. It can allow someone in a wheelchair who may have a severe disability to retrieve objects they cannot reach, are unable to lift or even see.

e. It can do the task of handing medical or dental instruments, supplies or tools to a medical or dental practitioner or a craftsperson reliably and at a lower cost than that of employing an assistant.

f. Further objects and advantages of my invention will become apparent from a consideration of the drawings and ensuing description.

### DESCRIPTION OF DRAWINGS

FIG. 1 is a schematic representation of the object retrieval system.

FIG. 2 is a drawing of a reference frame.

FIG. 3 is an isometric view of a machine readable label with a reference frame superimposed on it

FIG. 4 is a drawing of a machine readable label showing its reference frame and corners.

FIG. 5 shows an object of complex shape with four labels. Grasping zones are designated.

FIG. 6 shows an object of complex shape being picked up by a gripper

FIG. 7 is a flow chart of one way of locating an object for pickup.

Reference Numerals In Drawings

| | |
|---|---|
| 1 | Operating Sequence |
| 2 | start point |
| 20 | robot arm |
| 20a | base |
| 20b | shoulder joint |
| 20c | bicep |
| 20d | forearm |
| 20e | wrist |
| 22 | gripper |
| 23 | sensor output data from robot and scanner |
| 24 | control computer |
| 25 | control input data |
| 26 | scanner |
| 28 | scan pattern |
| 40 | planar surface |
| 42 | set of objects |
| 42a | stapler |
| 42b | box |
| 42c | glass |
| 42d | object of complex shape |
| 44 | machine readable or bar code label |
| 44a | top left corner |
| 44b | bottom left corner |
| 44c | top right corner |
| 44d | bottom right corner |
| 44e | target or center |
| 44m | machine readable code label |
| 44n | machine readable code label |
| 44o | machine readable code label |
| 44p | machine readable code label |
| 46 | reference frame |
| 46a | x axis |
| 46b | y axis |
| 46c | z axis |
| 46d | origin |
| 46m | reference frame |
| 46n | reference frame |
| 46o | reference frame |
| 46p | reference frame |
| 48 | zone for grasping object |
| 48' | zone for grasping object |
| 100 | object locating sequence |

### DESCRIPTION OF INVENTION u

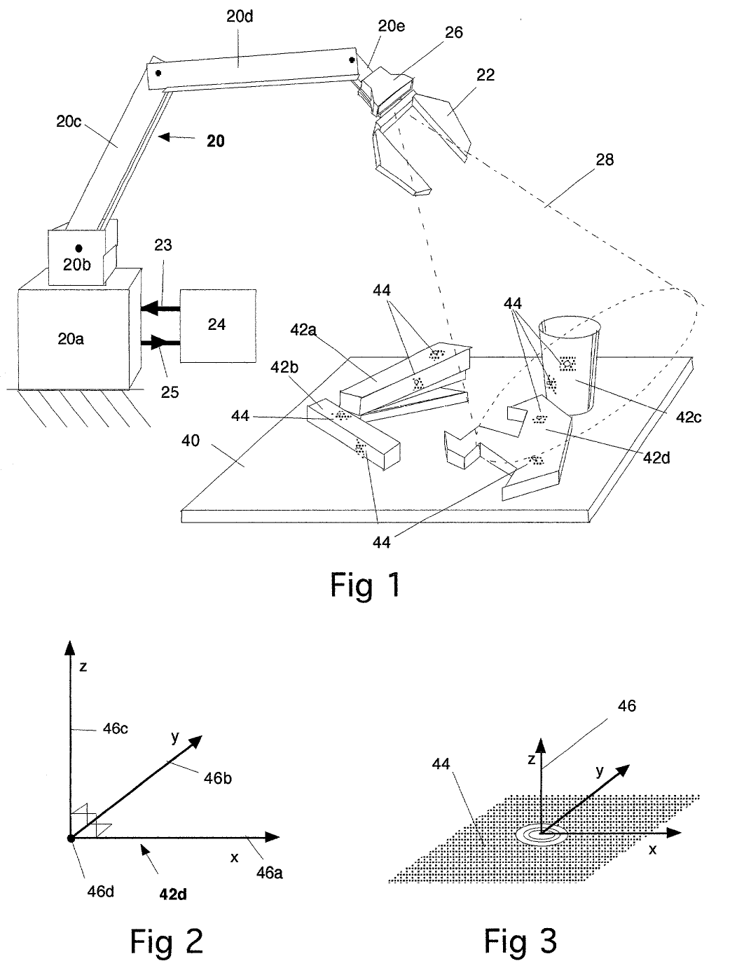

FIG. 1 is a schematic representation of a basic version of my object retrieval system. A manipulation device or robot arm 20 comprises a base 20a, a shoulder joint 20b, a bicep 20c, a forearm 20d, and a wrist 20e. Attached to wrist 20e are a gripper 22 with jaws which will flexibly conform themselves to a wide variety of objects and a label reading device or scanner 26. A control computer 24 sends control input data 23 and receives sensor output data 25. A scan pattern 28 is shown. Resting on a planar surface 44 are a set of objects: a stapler 42a, a box 42b, a glass 42c, and an object of complex shape 42d.

FIG. 2 is an isometric view of a geometric reference frame 46 which is comprised of an x axis 46a, a y axis 46b, a z axis 46c and an origin 46d.

FIG. 3 is an isometric view of a machine readable label 44 with a reference frame 46 shown in its proper location relative to label 44.

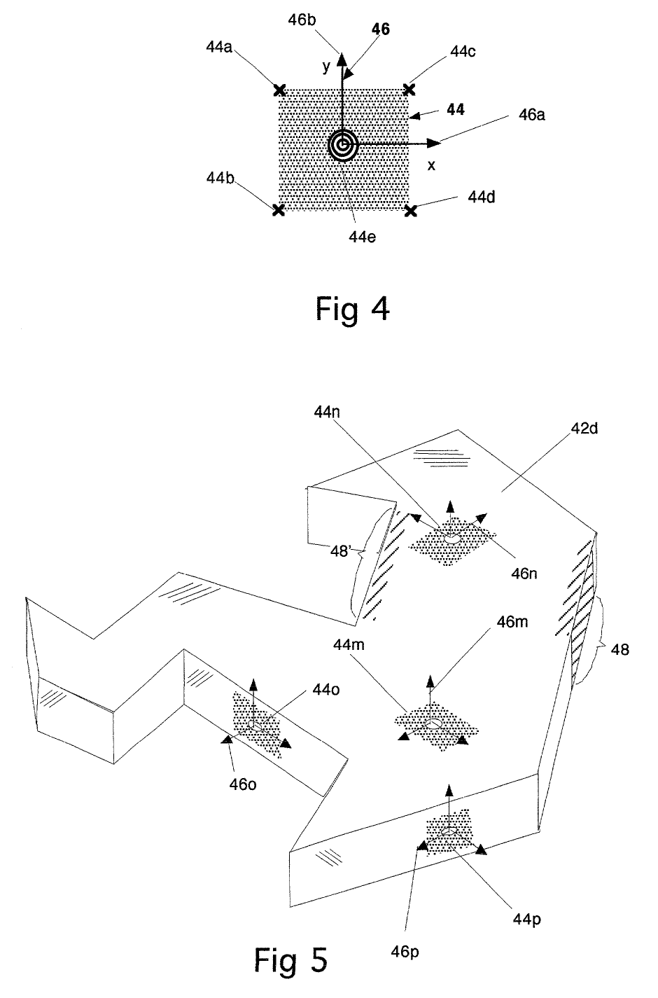

FIG. 4 shows a machine readable code label 44 viewed from directly overhead and some important features of label 44. Designated are a top left corner 44a, a bottom left corner 44b, a top right corner 44c, and a bottom right corner 44d. A target 44e is located at the center of label 44. A reference frame 46 is also shown, comprising an x axis 46a, and a y axis 46b. A z axis superimposed 44c cannot be seen from this angle.

FIG. 5 sows an isometric view of an object of complex shape 42d. Shown mounted on it are a set of four unique code labels 44m, 44n, 44o, and 44p, each of which has a unique reference frame 46m, 46n, 46o, and 46p. Shown also are a pair of grasping zones 48 & 48′.

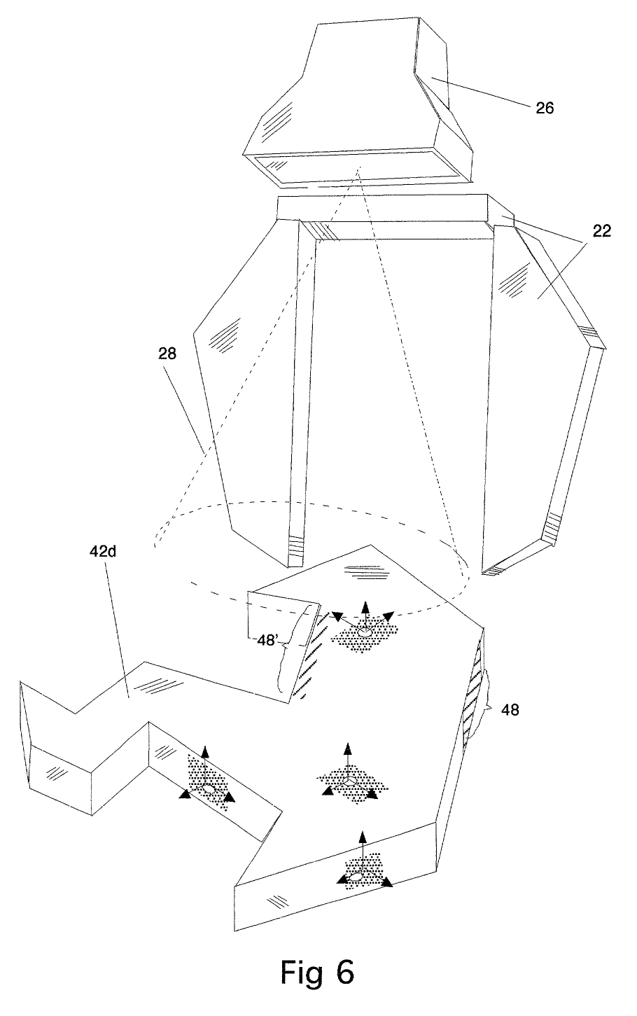

FIG. 6 shows object 42d being approached by gripper 22 for pickup. A scanner 26 is mounted on gripper 22. A pair of grasping locations 48 & 48′ are shown. A scan pattern 28 is also shown.

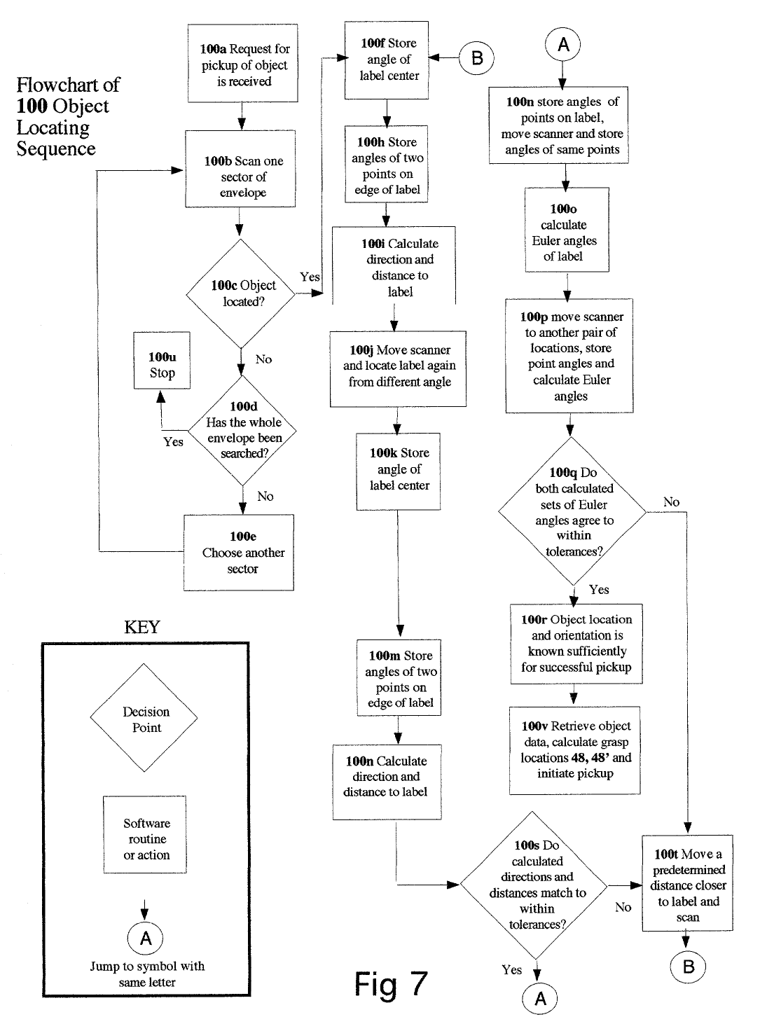

FIG. 7 is a flow chart of one way of locating an object for pickup. Sequence points 100a through 100u are given and a description of the action at each sequence point 100a through 100u is printed in the appropriate box.

Operation of Invention

In FIG. 1 all the elements of a basic version of my invention appear. It operates as follows [see FIG. 7].

Control computer 24 receives a request [100a] for pickup of an object 42, which is object 42d in this example [see FIG. 6]. Locating sequence 100 moves wrist 20e so that scanner 26 is pointing at the first sector in the sequence. Scanner 26 checks for the presence of one of the labels 44m, 44n, 44o, and 44p which are attached to object 42d. If one of these labels is not found, sequence 100 checks to see if all sectors have been scanned [100d]. If so, sequence 100 stops [100u]. If not, another sector is chosen, scanner 26 is pointed in the appropriate direction and scanning continues. [See FIG. 5] In this example label 44n attached to object 42d has been located [100c], The process would be the same if one of the other labels had been found. Labels are attached to each object at a sufficient number of locations to ensure that at least one is visible to scanner 26 at any angle. Sequence 100 calculates the angle from scanner 26 to the center or target 44e [see FIG. 4]. of label 44n. The angles to at least two points 44a, 44b, 44c, or 44d on label 44n are also stored [100h]. Label 44n is of a known size and shape, so sequence 100 can now calculate the distance to the center of label 44n. At sequence point 100j scanner 26 is moved and the process of locating and calculating distance is is repeated [100j, 100l, 100m, 100n]. The location of label 44n calculated from each position of scanner 26 is compared [100s]. If it is within a predetermined tolerance [100s], gripper 22 is close enough to determine the orientation of label 44n. If not, robot 22 moves scanner 26 closer [loot] and sequence 100 returns to point 100f and repeats the locating process. If the calculated positions do match to within tolerances [100s], sequence 100 moves through sequence points 100n, 100o and 100p and calculates the Euler angles of reference frame 46n.

Euler angles are a set of three angles which uniquely describe the orientation of any reference frame relative to any other reference frame in a coordinate system. They can be calculated by someone skilled in the art from two observations of angles to three points in a geometric figure of known size and shape taken from two different points in space [Fig 2, FIG. 3, FIG. 4]. This calculation can be done with trigonometry and matrix algebra. The preferred method is to use a motion control function library such as SpaceLib™, by Giovanni Legnani et al, University of Brescia—Mechanical Engineering Department, Via Branze 38, 25123 Brescia, Italy which runs under C++.

Sequence 100 then moves to point 100p where Euler angles of label 44n are calculated based on scanning data from another pair of points. If both sets of calculated Euler angles agree to within predetermined tolerances [100q], sequence 100 moves to point 100r. The location and orientation in space of label 44n are now known with sufficient accuracy to ensure successful pickup.

Control system 24 now retrieves necessary data about object 42d from a stored database or from data scanned from label 44n. This data may include but not be limited to the shape, weight, size, weight distribution, surface texture and fragility of object 42d. It will also include reference the positions of grasping locations 48 and 48′ relative to reference frame 46n. Sequence 100 now maneuvers gripper 22 to the correct position to grasp object 42d and picks it up [Fig 6].

Description and Operation of Other Alternative Embodiments

We have described one basic embodiment in the previous sections. Following are some additional embodiments of my object retrieval system:

a. In another embodiment, robot arm 22 is mounted to a fixed or mobile base and retrieves requested labeled objects 42 in a home, office, stockroom or warehouse. An operator sends the mobile base to the general location of the desired object and initiates a search as in FIG. 7.

b. In another embodiment robot arm 22 is mounted on the wheelchair of someone who may have severe paralysis. Objects 42 used by that person, for instance books, papers, telephones, grooming items and eating utensils are all labeled. The object retrieval system is used to access these items. Labels 44 can also be affixed to light switches, door handles, cabinet knobs, faucets and drawers, giving people who may have a severe disability greater ability to do things for themselves, increased quality of life and dignity.

c. In another embodiment robot arm 22 is attached to a fixed or mobile base in a medical environment. This could be in a hospital operating room . My object retrieval system picks up medical instruments and supplies when requested and hands them to a physician or other medical practitioner.

d. In another embodiment robot arm 22 is attached to a fixed or mobile base in a dental office. My object retrieval system picks up dental instruments and supplies when requested and hands them to a dentist or other dental practitioner.

e. In another embodiment robot 22 is attached to a fixed or mobile base in a workshop or other environment where a practitioner or craftsperson uses tools. It hands tools and/or supplies to the person who requests them

Conclusion, Ramifications and Scope

Thus the reader will see that the Object Locating and Retrieving System of the invention provides a way in which objects can be quickly and reliably retrieved in a free form environment. Objects need not be precisely located or oriented or placed in fixtures or racks. The system does not need to reference a set of prerecorded positions of objects.

For a person in a wheelchair who may have a paralysis disability this system will make it possible to quickly retrieve objects which had been out of reach. It provides a simple and easy way for the wheelchair user to access every day objects and objects they use in their work. Labels can be put on fixed objects such as light switches and faucets and stove burners and refrigerator handles, giving the user of this system quick, easy and inexpensive access to all of these.

For the medical or dental practitioner or the craftsperson who would ordinarily employ another person to hand them instruments and/or tools this system can reduce the cost and increase the reliability of accomplishing that task.

Accordingly, the scope of the invention should be determined not by the embodiments illustrated, but by the appended claims and their legal equivalents.

I claim:

1. A system comprising:
a. a set of one or more objects
b. a robot arm,
c. a control system for said robot arm,
d. a gripper mounted upon said robot arm, said gripper having conformable jaws to allow pickup of any of said objects
e. a set of one or more labels selected from the group consisting of machine readable labels and bar code labels, said set of labels affixed to each of said objects, said set of labels containing identifying data for said object,
f. a means for locating and decoding said labels, said means selected from the group consisting of cameras and optical scanners and bar code scanners,
g. a control sequence running on said control system which, using input data from said means for locating does the following:
1. accepts a request for one of said objects,
2. locates and identifies a label attached to said requested object,
3. causes a set of coordinates of said label to be calculated to a predetermined tolerance,
4. causes a reference frame for said label to be calculated,
5. inputs data from a source selected from the group consisting of said requested label and database records and records incorporated in said sequence,
6. calculates a gripper position for pickup of said requested object from said reference frame and said data,
7. moves said gripper to said position,
8. causes said gripper to grasp and pick up said requested object,
whereby objects of position and orientation previously unknown to said system can be automatically retrieved.

2. The system of claim 1 wherein said robot arm is mounted on a wheelchair.

3. The system of claim 1 wherein said robot arm is mounted on a base selected from the group consisting of fixed bases and mobile bases wherein said system retrieves objects selected from the group consisting of medical instruments and medical supplies and medical tools and medical records and hands them to a person selected from the group consisting of physicians and surgeons and nurses and medical technicians and medical practitioners.

4. The system of claim 1 wherein said robot arm is mounted on a base selected from the group consisting of fixed bases and mobile bases wherein said system retrieves objects selected from the group consisting of medical instruments and medical supplies and medical tools and medical records and places them in a different location.

5. The system of claim 1 wherein said robot arm is mounted on a base selected from the group consisting of fixed bases and mobile bases wherein said system retrieves objects selected from the group consisting of dental instruments and dental supplies and dental tools and dental records and hands them to a person selected from the group consisting of dentists and oral surgeons and nurses and dental technicians and dental practitioners.

6. The system of claim 1 wherein said robot arm is mounted on a base selected from the group consisting of fixed bases and mobile bases wherein said system retrieves objects selected from the group consisting of dental instruments and dental supplies and dental tools and dental records and places them in a different location.

7. The system of claim 1 wherein said robot arm is mounted on a base selected from the group consisting of fixed bases and mobile bases wherein said system retrieves objects selected from the group consisting of hand tools and hand power tools and books and papers and office supplies and hands them to a person selected from the group consisting of mechanics and craftspeople and jewelers and artists and technicians.

8. The system of claim 1 wherein said robot arm is mounted on a base selected from the group consisting of fixed bases and mobile bases wherein said system retrieves objects selected from the group consisting of hand tools and hand power tools and books and papers and office supplies and places them in a different location.

9. The system of claim 1 wherein said robot arm is mounted on a base selected from the group consisting of fixed bases and mobile bases and wherein said system retrieves objects from the group consisting of inventories and libraries and stockrooms and warehouses and stockpiles.

10. A system comprising:
a. a set of one or more objects,
b. a first means for grasping any of said objects,
c. a second means for moving said first means in three space,
d. a control system for said first and second means,
e. a third means for locating and decoding machine readable labels,
f. a set of one or more of said machine readable labels affixed to each of said objects, said labels having encoded on them data pertinent to said objects,
g. a control sequence running on said control system which, using input data from said third means does the following:
1. accepts a request for one of said objects,
2. locates and identifies a label attached to said requested object,
3. causes a set of coordinates of said label to be calculated to a predetermined tolerance,
4. causes a reference frame for said label to be calculated,
5. inputs data from a source selected from the group consisting of said requested label and database records and records incorporated in said sequence,
6. calculates a position for pickup of said requested object for said first means from said label reference frame and said data,
7. moves said first means to an said position,
8. causes said first means to grasp and second means to pick up said requested object,
whereby objects of position and orientation previously unknown to said system can be automatically retrieved.

11. The system of claim 10 wherein said second means is mounted on a wheelchair.

12. The system of claim 10 wherein said second means is mounted on a base selected from the group consisting of fixed bases and mobile bases wherein said system retrieves objects selected from the group consisting of medical instruments and medical supplies and medical tools and medical records and hands them to a person selected from the group consisting of physicians and surgeons and nurses and medical technicians and medical practitioners.

13. The system of claim 10 wherein said v is mounted on a base selected from the group consisting of fixed bases and mobile bases wherein said system retrieves objects selected from the group consisting of medical instruments and medical supplies and medical tools and medical records and places them in a different location.

14. The system of claim 10 wherein said second means is mounted on a base selected from the group consisting of fixed bases and mobile bases wherein said system retrieves objects selected from the group consisting of dental instruments and dental supplies and dental tools and dental records and hands them to a person selected from the group consisting of dentists and oral surgeons and nurses and dental technicians and dental practitioners.

15. The system of claim 10 wherein said second means is mounted on a base selected from the group consisting of fixed bases and mobile bases wherein said system retrieves objects selected from the group consisting of dental instruments and dental supplies and dental tools and dental records and places them in a different location.

16. The system of claim 10 wherein said second means is mounted on a base selected from the group consisting of fixed bases and mobile bases wherein said system retrieves objects selected from the group consisting of hand tools and hand power tools and and books and papers and office supplies and hands them to a person selected from the group consisting of mechanics and craftspeople and jewelers and artists and technicians.

17. The system of claim 10 wherein said second means is mounted on a base selected from the group consisting of fixed bases and mobile bases wherein said system retrieves objects selected from the group consisting of hand tools and hand power tools and and books and papers and office supplies and places them in a different location.

18. The system of claim 10 wherein said second means is mounted on a base selected from the group consisting of fixed bases and mobile bases and wherein said system retrieves objects from the group consisting of inventories and libraries and stockrooms and warehouses and stockpiles.
